(19) United States
(12) Patent Application Publication
(10) Pub. No.: US 2026/0330485 A1
(43) Pub. Date: Oct. 22, 2026

(54) GENERATIVE ARTIFICIAL INTELLIGENCE-BASED WORKFLOWS

(71) Applicant: Adobe Inc., San Jose, CA (US)

(72) Inventors: Rishabh PURWAR, Faridabad (IN); Khyathi VAGOLU, Hyderabad (IN); Himanshu GUPTA, Noida (IN); Gaurav BHARGAVA, Noida (IN); Ayush GUPTA, Meerut (IN); Madhupriya GUPTA, Faridabad (IN)

(21) Appl. No.: 19/185,081

(22) Filed: Apr. 21, 2025

(51) Int. Cl. G06Q 30/0201

(52) U.S. Cl. CPC G06Q 30/0201

(57) ABSTRACT

In various examples, a workflow assistant tool utilizes a machine learning model to automate the creation of workflows for an application based on natural language input. For example, natural language input describing a workflow is accessed. A language model generates suggested workflow activities based on the natural language input. Relevant predefined workflow activities are determined by performing a semantic search between semantic vector embeddings of the suggested workflow activities and predefined workflow activities. The language model generates a workflow graph data structure based on the natural language input and predefined workflow activity nodes, and the relevant predefined workflow activities. A structured data object corresponding to the workflow is generated, which can be utilized by the application to display the workflow to the user.

### BACKGROUND

Users often rely on analytics services to collect and analyze data. Such analytics services can provide insights based on analyzed data. Users, in particular, use analytics services to conduct analytics sessions on data (e.g., user clickstream data) while attempting to gain insights. By way of example, an analytics service can answer questions, such as which mobile devices make the most product conversions. The analytics service can also quantify the success of a marketing campaign. However, a user (e.g., a data analyst) of the analytics services must make many decisions when it comes to gathering insights from an increasing amount of data and capabilities in processing the data, and the user needs to have the ability to quickly query, analyze, and draw inferences from the data. As such, machine learning models are useful tools that when integrated into the analytics service can help users gather insights by filtering, collecting, reviewing, or otherwise interacting with the data and capabilities of the analytics services.

For example, various types of artificial intelligence (AI) models can perform various tasks such as interpreting natural language (NL) prompts and generating outputs based on the natural language prompts. These large language models (LLMs) can be trained on a large corpus of data and extract or otherwise generate responses to questions related to the large corpus of data. For example, an LLM can be integrated with the analytics services to facilitate querying, analyzing, and drawing inferences from the data maintained by the analytics services.

### SUMMARY

Embodiments described herein are directed to a workflow assistant tool that uses a machine learning model to generate and/or modify workflows for various marketing and/or analytics services based on natural language (NL) queries provided by a user. Furthermore, in such embodiments, the workflow assistant tool leverages natural language processing (NLP) and machine learning models to automate the generation of workflows (e.g., without user intervention), allowing users to create, edit, or otherwise manage workflows using natural language queries without the need to compose the workflows themselves and/or the technical expertise to interact with the functions and/or operations provided by the various marketing and/or analytics services.

In various embodiments, the workflow assistant tool includes a multistep Retrieval-Augmented Generation (RAG)-based prompt engineering pipeline that interprets natural language queries and generates workflows. For example, the workflow assistant tool obtains user input (e.g., a natural language query) corresponding to a natural language description indicating a workflow the user is attempting to generate. An LLM generates a set of suggested workflow activities based on a prompt with the user input and instructions to generate the set of suggested workflow activities. A semantic search is performed to determine relevant predefined workflow activities available in the application based on the suggested workflow activities. For instance, the most relevant predefined workflow activities are identified by computing a cosine similarity between a semantic vector embedding of each suggested workflow activity to the semantic vector embeddings of the predefined workflow activities. Using the relevant predefined workflow activities, the LLM generates a workflow graph data structure with natural language configuration descriptions for each workflow activity node of the workflow graph data structure based on a prompt with the user input and predefined workflow activity nodes corresponding to each of the relevant workflow activities. For instance, each predefined workflow activity node includes properties of the predefined workflow activity, such inbound cardinality corresponding to the number of workflow activities that can transition to the workflow activity, outbound cardinality corresponding to the number of workflow activities that can transition from the workflow activity, and/or workflow activity type. In certain embodiments, the workflow graph data structure undergoes validation and self-correction procedures. After the workflow graph data structure is validated, a structured data object is generated by translating the workflow graph data structure into a domain-specific language (DSL) format, such as a JSON, XML, and/or the like. In this regard, the application can utilize the structured data object to display the workflow to the user.

In certain embodiments, fully configured workflow activities of the structured data object are generated using the natural language descriptions of the workflow activities. In this regard, the workflow of the structured data object can be executed based on the fully configured workflow activities of the structured data object. In certain embodiments, the fully configured workflow activities can be generated in parallel to reduce processing time based on a corresponding dependency between each of the workflow activities of the workflow.

### BRIEF DESCRIPTION OF THE DRAWINGS

The present disclosure is described in detail below with reference to the attached drawing figures, wherein:

FIG. 1 depicts an environment in which one or more embodiments of the present disclosure can be practiced.

FIG. 2 depicts an environment in which a workflow assistant tool generates a structured data object corresponding to a workflow described in a natural language prompt, in accordance with at least one embodiment.

FIG. 3 depicts a user interface that accepts a natural language prompt is provided to the workflow assistant tool, in accordance with at least one embodiment.

FIG. 4 depicts a user interface displaying a workflow generated based on a natural language prompt, in accordance with at least one embodiment.

FIG. 5 depicts a user interface displaying a workflow activity of a workflow generated based on a natural language prompt, in accordance with at least one embodiment.

FIG. 6 depicts a user interface displaying a workflow activity of a workflow generated based on a natural language prompt, in accordance with at least one embodiment.

FIG. 7 depicts an example process flow for generating a workflow based on a natural language prompt, in accordance with at least one embodiment.

FIG. 8 is a block diagram of a Large Language Model that uses particular inputs to make particular predictions, according to some embodiments.

FIG. 9 is a block diagram of an example computing environment in which embodiments described herein may be employed.

### DETAILED DESCRIPTION

Various terms are used throughout this description. Definitions of some terms are included below to provide a clearer understanding of the ideas disclosed herein.

As used herein, the term “analytics service” and/or “marketing service” refers to cloud computing services that provide users access to data that is used to generate insights. For example, the analytics service collects, processes, and provides operations that help users gain insights and make decisions. In one example, the analytics service collects marketing campaign data and allows users to process this data to gain insights into successful marketing campaigns. Furthermore, the analytics service, for example, is accessible to the user through an application and can perform various operations using the data to generate content that enables users to determine insights associated with the data. In an embodiment, the analytics service is a service that is capable of tracking, measuring, and analyzing data, such as website traffic and customer behavior. In one example, the analytics service provides user access to a workflow that is used to interact with data maintained by the service. In this way, an analytics service may collect or obtain data from various channels, such as websites, mobile applications, videos, social media, etc. Continuing with this example, through the workflow, the user can interact with the analytics service and breakdown, filter, query, and visualize data. As such, the analytics service may provide real-time data analysis such that various insights related to user interactions, campaign performance, and/or content engagement may be viewed. Various features of an analytics service may include, by way of example only, user journey analysis and conversion analysis (e.g., in association with particular channels or campaigns), predictive insights (e.g., forecasting trends or issues), customized metrics to enable tailored information, and/or the like.

As used herein, the term “workflow” refers to a sequence of tasks or activities that are organized and executed to achieve a specific goal or complete a particular process. Furthermore, in some examples, a workflow involves the systematic arrangement of steps, where the steps represent a distinct action and/or operation to be performed (e.g., by an application and/or service frontend). In an embodiment, the workflows define a process and/or data flow between one task to another, specifying the order in which tasks should be completed and the dependencies (e.g., transitions) between them. By way of example, the user provides a natural language query to the machine learning model which, in response, populates the workflow with a particular workflow activity to accomplish the tasks and/or subtasks indicated in the natural language query. In various embodiments, the workflow includes a set of segments and a set of conditions corresponding to features, operations, and/or tools provided by the application and/or the analytics service. For example, the workflow includes a first workflow activity to analyze data, a second workflow activity to perform audience segmentation, and a third workflow activity to generate a personalized email for the audience segment.

As used herein, the term “workflow activity” refers to a discrete, configurable unit within a workflow that performs a specific function or task. For example, a particular workflow activity represents an individual step in a sequence of actions designed to achieve a particular goal or complete a process represented by a workflow. In various embodiments, workflow activities include operations such as data enrichment, filtering, sorting, sending notifications, or executing business logic. In one example, a workflow activity is defined by its inputs, outputs, and the conditions under which it operates. In the context of marketing and analytics services, for example, workflow activities enable the automation and orchestration of tasks, allowing users to create, edit, and manage complex workflows. In various embodiments, users provide natural language inputs to the workflow assistant tool to cause the machine learning model to generate workflow activities.

A “graph data structure,” such as a knowledge graph, is a structured representation of information that organizes entities and their relationships in a graph format (e.g., as interconnected nodes and edges). Entities, such as objects, events, situations, or abstract concepts, are referred to as “nodes,” and relationships between the nodes are referred to as “edges.” In this regard, a “workflow graph data structure” refers to a graph data structure representing a workflow where each workflow activity of the workflow is represented as a node, referred to as a “workflow activity node” and edges represent the transitions (e.g., dependencies) between each of the workflow activities. For example, an example workflow graph data structure includes a first workflow activity node representing a workflow activity to analyze data, a second workflow activity node representing a workflow activity to perform audience segmentation, a third workflow activity node representing a workflow activity to generate a personalized email for the audience segment, a first edge representing the transition between the first and second workflow activity node indicating that the second workflow activity node is dependent on the first workflow activity node, and a second edge representing the transition between the second and third workflow activity node indicating that the third workflow activity node is dependent on the second workflow activity node.

As used herein, the term “workflow assistant” refers to a user interface element of an application that allows a user to interact with a machine learning model. By way of example, the workflow assistant includes a query box, a chat box, and/or other interface that allows the user to submit queries (e.g., natural language questions) and obtain workflows and/or workflow activities generated by a machine learning model. Continuing this example, the workflow assistant provides an interactive interface allowing users to input a natural language query to the machine learning model to facilitate the processing of data and/or generation of workflows. In various embodiments, the workflow assistant includes various user interface elements to facilitate interactions with the machine learning model such as: a message area where queries from the user and response from the machine learning model are displayed; an input box to provide natural language queries and/or prompts; a send button to submit natural language queries and/or prompts; and a workspace to view, edit, create, and/or execute workflows.

As used herein, the term “workflow assistant tool” refers to an application service, or other executable code that is integrated with the application, the marketing service, and/or the analytics services and provides a machine learning model that generates workflows and/or workflow activities based on input from the user. For example, the workflow assistant tool is integrated into the application (e.g., through the workflow assistant user interface element) and the analytics service, allowing the user to provide queries through the workflow assistant of the application, and in turn, the workflow assistant tool causes the machine learning model to generate workflows.

A “query” refers to text that is used as input to a machine learning model that instructs the machine learning model to produce a specific workflow and/or workflow activity to process data maintained in a database or other data store. In one example, a query is obtained from the user and a prompt to the machine learning model is generated based on the query. In other examples, the query is provided directly to the machine learning model as the prompt.

As used herein, the term “Retrieval-Augmented Generation” (RAG) refers to a technique that enhances the capabilities of machine learning models by incorporating information retrieval. For example, RAG modifies interactions with a large language model (LLM) so that the LLM responds to user queries by referencing a specified set of documents, using this information to augment the data drawn from its own training. This allows LLMs to provide more accurate and domain-specific responses by leveraging external, up-to-date information. In various embodiments, RAG is used to generate prompts to enable the machine learning model of the workflow assistant tool to generate workflows and/or workflow activities based on augmented data.

Conventional systems for configuring workflows in marketing and analytics services are often complex and time-consuming. These systems require users to have a deep understanding of user interfaces, internal structures, and data models. Furthermore, the process of manually setting up parameters, identifying tables and columns, determining relationships, and applying functions and operators can be tedious and is error-prone. In addition, different marketing services and/or analytics services provide different functions, operations, and user interfaces that add to the complexity of setting up workflows. Furthermore, these different services operate using domain-specific languages, and knowledge or experience using one service does not necessarily translate to other services.

In addition, modern computing systems maintain, track, store, and generate large amounts of data that can be stored in various data stores. For example, customer data and sales data can be updated and generated frequently. In addition, this data is often stored in different databases using different schemas that can add to the complexity and amount of knowledge required by users to configure and generate workflows. Furthermore, database tables, in modern computing environments, can link to other databases using different schemas, which are not necessarily intuitive and/or user-friendly. Therefore, determining the location of relevant data when generating workflows adds additional layers of complexity requiring further technical expertise to efficiently and easily configure these workflows.

This complexity results in a steep learning curve and significant time investment, making it challenging for users to efficiently create and manage workflows. In general, this shortcoming is particularly challenging because users of these services are generally non-technical users with experience, training, and backgrounds in other fields. For example, users of these various marketing and analytics services often have backgrounds and experience in business and advertising with little to no experience in computer engineering and computer programing. Conventional systems provide little to no automated support for workflow generation and, therefore, require these users to take the time to learn the technical aspect of these services. For example, users may be required to search a knowledge base or technical descriptions of various functions and operations provided by these services.

In contrast, embodiments described herein include a generative artificial intelligence (AI)-based workflow assistant tool that utilizes natural language processing (NLP) to automate, on behalf of the user, the generation of workflows. This workflow assistant tool allows users to create and manage workflows using simple natural language queries provided through a user interface, significantly reducing the time and complexity involved in workflow configuration. For example, workflow assistant tools help process, digest, understand, query, or otherwise interact with documentation, websites, the Internet, or other collections of documents to help the user generate, configure, and/or modify workflows for the different marketing and analytics services. For example, a machine learning model, such as an LLM, is trained and used as an AI assistant to enable users to interact with the LLMs and perform various operations in connection with workflows corresponding to particular marketing and/or analytics services.

Accordingly, embodiments described herein generally relate to a multistep RAG-based prompt engineering pipeline of the workflow assistant tool that interprets natural language queries and generates workflows encoded or otherwise stored in a structured data object such as JavaScript Object Notation (JSON) format. For example, a user can request to create a workflow that sends personalized emails to customers based on their purchase history and engagement with previous campaigns. The workflow assistant tool processes this query, identifies the necessary workflow activities, generates and validates a workflow graph data structure corresponding to the workflow with natural language descriptions of each of the workflow activities, and generates a structured data object corresponding to the workflow without additional user input. This approach not only enhances efficiency and accuracy but also makes workflow configuration accessible to non-technical users, providing a scalable and cost-effective solution for these various services.

In one example, the process begins with obtaining a user input (e.g., a natural language query inputted into a user interface of an application) corresponding to a natural language description indicating a workflow the user is attempting to generate. In some examples, a virtual assistant, a query box, and/or other user interface elements are used obtain the user input, which includes a natural language description of a workflow.

An LLM generates a set of suggested workflow activities based on a prompt with the user input and instructions to generate a set of suggested workflow activities based on the user input. A semantic search is performed to determine relevant predefined workflow activities available in the application based on the suggested workflow activities. For instance, the most relevant predefined workflow activities are identified by computing a cosine similarity between a semantic vector embedding of each suggested workflow activity to the semantic vector embeddings of the predefined workflow activities. For each suggested workflow activity, the predefined workflow activity with the highest similarity score is selected as the most relevant predefined workflow activity. In certain embodiments, in order to generate the semantic vector embeddings of the predefined workflow activities, relevant documentation for a particular predefined workflow activity can be determined using a ranking algorithm, such as Best Match 25. A semantic vector embedding for the particular predefined workflow activity can be generated by applying an embedding model, such as OpenAI's text-embedding-3-large model, to the relevant documentation.

Using the relevant predefined workflow activities, the LLM generates a workflow graph data structure with natural language configuration descriptions for each workflow activity node of the workflow graph data structure based on a prompt with the user input and predefined workflow activity nodes corresponding to each of the relevant workflow activities. For instance, each predefined workflow activity node includes properties of the predefined workflow activity, such inbound cardinality corresponding to the number of workflow activities that can transition to the workflow activity, outbound cardinality corresponding to the number of workflow activities that can transition from the workflow activity, and/or workflow activity type.

In certain embodiments, the workflow graph data structure undergoes validation and self-correction procedures. For example, node validation is performed to ensure all nodes of the workflow graph data structure exist in the predefined workflow activity nodes. As another example, edge validation is performed to check if the edges of the workflow graph data structure connect valid nodes from the predefined workflow activity nodes. As another example, cardinality validation is performed to verify that the number of inbound and outbound transitions for each node of the workflow graph data structure complies with the cardinality rules defined in the predefined workflow activity nodes. In certain embodiments, if there is an error identified, the LLM can generate a corrected workflow graph data structure.

After the workflow graph data structure is validated, a structured data object is generated by translating the workflow graph data structure into a domain-specific language (DSL) format, such as a JSON, XML, and/or the like. In this regard, the application can utilize the structured data object to display the workflow to the user.

In certain embodiments, fully configured workflow activities of the structured data object are generated using the natural language descriptions of the workflow activities. In this regard, the workflow of the structured data object can be executed based on the fully configured workflow activities of the structured data object. In certain embodiments, the fully configured workflow activities can be generated in parallel (e.g., to reduce processing time) based on a corresponding dependency between each of the workflow activities of the workflow.

Advantageously, embodiments described herein enable users to generate workflows with improved ease and efficiency, enhanced accuracy, scalability, user-friendliness, and cost-effectiveness. For example, by leveraging generative AI and a multistep RAG-based prompt engineering pipeline, the workflow assistant tool ensures the accuracy of the generated workflows, reducing the likelihood of errors. The workflow assistant tool, in various embodiments, processes a wide range of natural language queries and generates various workflows, making it scalable for different use cases and/or services. Additionally, the workflow assistant tool allows users to configure, generate, and/or modify workflows using simple natural language queries, eliminating the need for a deep understanding of the user interface and internal schema structures. This approach not only enhances efficiency and accuracy but also makes workflow configuration accessible to non-technical users, providing a scalable and cost-effective solution for various industries.

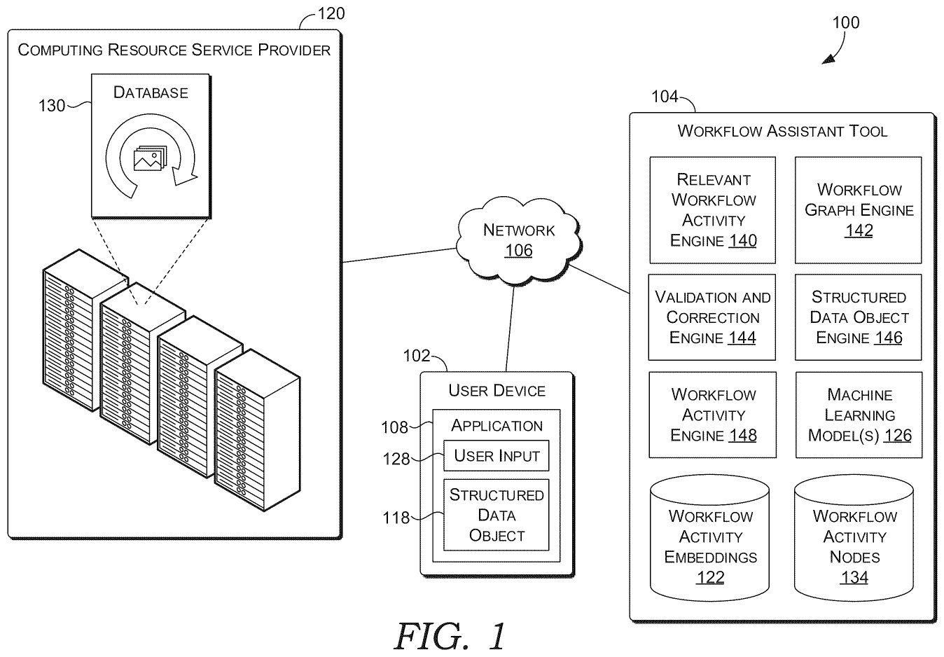

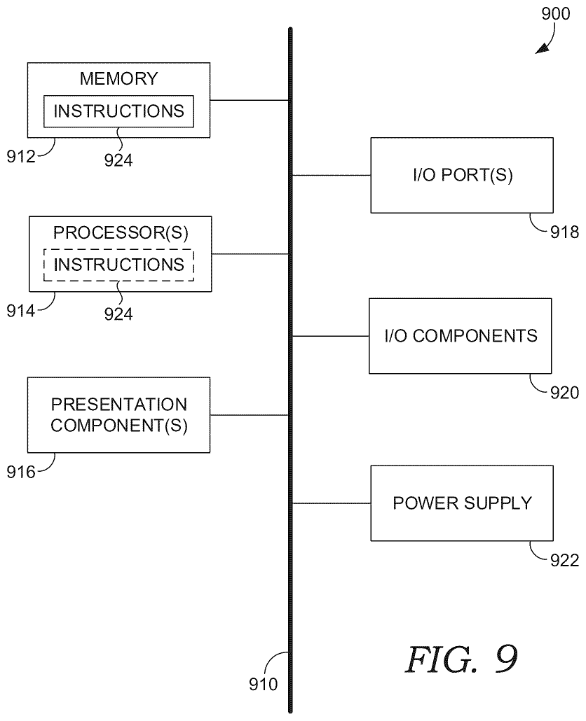

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 9.

It should be understood that operating environment 100 shown in FIG. 1 is an example of one suitable operating environment. Among other components not shown, operating environment 100 includes a user device 102, a workflow assistant tool 104, and a network 106. Each of the components shown in FIG. 1 can be implemented via any type of computing device, such as one or more computing devices 900 described in connection with FIG. 9, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the workflow assistant tool 104 includes multiple server computer systems cooperating in a distributed environment to perform the operations described in the present disclosure. Continuing this example, the workflow assistant tool 104 includes a machine learning model 126 executed by a server computer system of the computing resource service provider 120 and an annotated schema 122 data store generated based on a database 130 provided by the computing resource service provider 120 to users such as a user operating the user device 102 through the application 108.

User device 102 can be any type of computing device capable of being operated by an entity (e.g., individual or organization) and that obtains data from the workflow assistant tool 104 and/or a data store that can be facilitated by the workflow assistant tool 104 (e.g., a server operating as a frontend for the data store) and/or the computing resource service provider 120 (e.g., the database 130). The user device 102, in various embodiments, has access to or otherwise maintains the database 130, which stores data useable for marketing and/or analytics. For example, the application 108 executes workflow activities using data maintained in the database 130 to generate marketing and/or analytics information for a user.

In various embodiments, a workflow can be displayed through application 108 via user device 102 to display the various workflow activities of a suggested workflow. For example, the workflow activities of the suggested workflow may include natural language descriptions of the workflow activity to indicate how the workflow activity should be configures to achieve a desired outcome. In various embodiments, workflows, when each workflow activity of the workflow is fully configured, when executed by the application 108 and/or other component illustrated in FIG. 1 (e.g., the computing resource service provider 120), interacts with relevant data schemas, applies specific conditions, and produces desired outcomes. For example, a workflow activity retrieves customer purchase data, filters by customers who made purchases in the last 30 days, enriches customer profiles with additional information, and sends personalized email campaigns to the filtered customers.

In various embodiments, the user can leverage workflow activities to automate complex processes, streamline operations, and enhance efficiency. For example, by defining and configuring workflow activities, users can automate repetitive tasks, ensure consistency in data processing, determine insights from data, track customer activity, generate marketing campaigns, and achieve accurate and timely results. In an embodiment, workflow activities enable users to create sophisticated workflows that can handle a wide range of tasks, from data queries to multistep processes that query data and perform operations.

In some implementations, user device 102 is the type of computing device described in connection with FIG. 9. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice.

In various embodiments, the application 108 includes any application capable of facilitating the exchange of information between the user device 102 and the workflow assistant tool 104. For example, the application 108 is an analytics application that tracks, analyzes, and/or optimizes various interactions with customers across multiple communication channels and over an interval of time. Continuing this example, the application 108 provides data integration, journey mapping, segmentation and personalization, predictive analytics, journey optimization, and reporting and dashboards to provide users with tools to make data-driven decisions. In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and/or workflow assistant tool 104. In some cases, the application 108 is integrated into the operating system (e.g., as a service). It is therefore contemplated herein that “application” be interpreted broadly. Some example applications include ADOBE® Customer Journey Analytics, a cloud-based analytics service.

For cloud-based implementations, for example, the application 108 is utilized to interface with the functionality implemented by the workflow assistant tool 104 and/or computing resource service provider 120. In some embodiments, the components, or portions thereof, of the workflow assistant tool 104 are implemented on the user device 102 or other systems or devices. Thus, it should be appreciated that the workflow assistant tool 104, in some embodiments, is provided via multiple devices arranged in a distributed environment that collectively provide the functionality described herein. Additionally, other components not shown can also be included within the distributed environment.

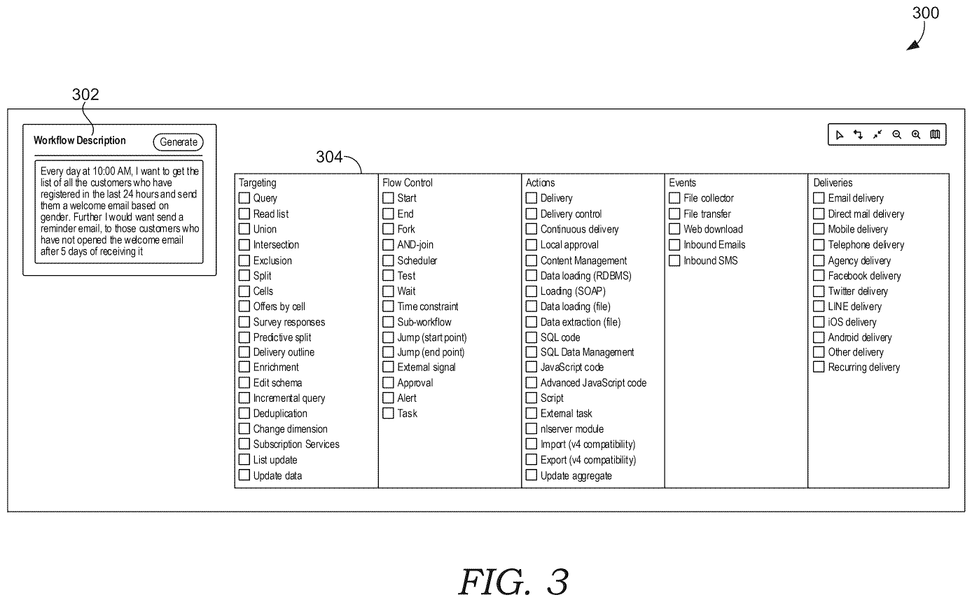

As illustrated in FIG. 1, the user device 102 obtains a user input 128 through the application 108. For example, a user interface of the application 108, as illustrated below in FIG. 3, provides a text box or other user interface element to enable the user to provide the user input 128. In various embodiments, the user input 128 includes natural language queries provided by users that are utilized by the workflow assistant tool 104 to generate workflow activities encoded or otherwise stored in a structured data object. For example, the user input 128 is processed by the workflow assistant tool 104 to interpret, determine, or otherwise obtain the user's intent and break down the user input 128 into a workflow.

In an embodiment, the user input 128 includes a conversational command that specifies an outcome of a particular workflow. For instance, as shown in the example of FIG. 3, a user might input a natural language query such as “Every day at 10:00 AM, I want to get the list of all the customers who have registered in the last 24 hours and send them a welcome email based on gender. Further I would want send a reminder email, to those customers who have not opened the welcome email after 5 days of receiving it.” The application 108 and/or user device 102, in various embodiments, provides the user input 128 to the workflow assistant tool 104 to enable the workflow assistant tool 104 to generate a workflow based on the user input 128. In such embodiments, the workflow assistant tool 104 utilizes one or more machine learning model(s) 126 to perform various tasks to generate the workflow and the structured data object 118 that, as a result of being executed by the application 108 and/or other component illustrated in FIG. 1 (e.g., computing resource service provider 120 and/or database 130), causes display of the workflow and/or causes the workflow to be executed. FIG. 3 is an example user interface 300 of an application that provides access to a workflow assistant tool, according to some embodiments. As can be understood, a user inputs a natural language query into UI element 302 in order to enable the workflow assistant tool to generate a workflow based on the user input. Each of the user interfaces 300, 400, 500, and 600 and any other user interfaces described herein comprise interfaces with applications provided using a combination of hardware, firmware, and/or software. The user interfaces can include additional user interface elements to enable users to interact with an application such as the application 108 of FIG. 1.

Returning to FIG. 1, in various embodiments, relevant workflow activity engine 140 of the workflow assistant tool 104 causes a large language model (LLM) (e.g., machine learning model(s) 126) to generate a set of suggested workflow activities based on a prompt with the user input 128 and instructions to generate a set of suggested workflow activities based on the user input 128. A language model is a statistical and probabilistic tool that determines the probability of a given sequence of words occurring in a sentence (e.g., via next sentence prediction [NSP] or masked language modeling [MLM]). In this way, it is a tool that is trained to predict the next word in a sentence. A language model is called a large language model when it is trained on an enormous amount of data. Some examples of LLMs are Open Pre-trained Transformer (OPT), Fine-tuned Language Net-Text-to-Text Transfer Transformer (FLAN-T5), Bidirectional and Auto-Regressive Transformers (BART), GOOGLE's® Bidirectional Encoder Representations from Transformers (BERT), and OpenAI's® Generative Pre-trained Transformer 2 (GPT-2), GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. In embodiments, an LLM generates representations of text, acquires world knowledge, and/or develops generative capabilities. As described, in some embodiments, relevant workflow activity engine 140, workflow graph engine 142, validation and correction engine 144, structured data object engine 146, workflow activity engine 148, machine learning model(s) 126, and/or the workflow assistant tool 104 takes on the form of an LLM, but various other machine learning models can additionally or alternatively be used. In this regard, in certain examples, as LLMs are trained on a wide range of unlabeled data available on the internet and are capable of answering questions by inferring and parsing natural language data, the LLM can predict hypothetical workflow activities necessary for a workflow based on an input query.

In various embodiments, the database 130 includes natural language descriptions of predefined workflow activities to provide detailed information regarding the workflow activities available in application 108 and/or workflow assistant tool 104. For example, for a query workflow activity, database 130 can include a natural language description of the predefined “query” workflow activity indicating “a query lets you select a target according to criteria. You can associate a segment code to the query result and insert additional data into it.” An example of predefined workflow activities available in application 108 and/or workflow assistant tool 104 is shown in workflow activities tab 304 of FIG. 3.

Returning to FIG. 1, in various embodiments, the workflow assistant tool 104 generates semantic vector embeddings for the natural language descriptions of the predefined workflow activities using the machine learning model 126 and stores the semantic vector embeddings in the workflow activity embeddings 122 data store. For example, the semantic vector embeddings capture the semantic meaning of each of the predefined workflow activities and are stored in a vector database. As a specific example, relevant documentation for a particular predefined workflow activity can be determined from database 130 using a ranking algorithm, such as Best Match 25. A semantic vector embedding of a particular length (e.g., 1536) for the particular predefined workflow activity can be generated by applying an embedding model (e.g., machine learning model 126), such as OpenAI's® text-embedding-3-large model, to the relevant documentation.

In various embodiments, relevant workflow activity engine 140 of the workflow assistant tool 104 identifies the most relevant predefined workflow activities from the predefined workflow activities of database 130 by applying a semantic search between a semantic vector embedding of each suggested workflow activity to the semantic vector embeddings of the predefined workflow activities as stored in workflow activity embeddings 122 data store. For example, relevant workflow activity engine 140 of the workflow assistant tool 104 computes the cosine similarity between a semantic vector embedding of each suggested workflow activity to the semantic vector embeddings of the predefined workflow activities to identify the most relevant workflow activity. In various embodiments, the workflow activity with the highest similarity score (e.g., or a similarity score above a threshold) to each of the suggested workflow activities are determined to be relevant and used. In various embodiments, relevant workflow activity engine 140 generates semantic vector embeddings of the set of suggested workflow activities by applying each suggested workflow activity to machine learning model 126 (e.g., an embedding model, such as OpenAI's® text-embedding-3-large model).

Continuing with the example described in relation to FIGS. 3-6, the following set of relevant predefined workflow activities may be output based on the natural language query input by the user:
Query: Every day at 10:00 AM, I want to get the list of all the customers who have registered in the last 24 hours and send them a welcome email based on gender. Further, I would want to send a reminder email to those customers who have not opened the welcome email after 5 days of receiving it.
Filtered Activities with Similarity Scores:
   Query Activity: 9.871148765087128
   Email Delivery Activity: 9.593329429626465
   Schedule Activity: 9.2631664872169495
   Split Activity: 9.215238690376282
   Wait Activity: 8.9738214015960693
   Start Activity: 8.759959452151045
   Enrich Activity: 8.5630902853390967
   End Activity: 8.4688107091897358
   Fork Activity: 7.418544923153828
   Dedup Activity: 7.3630675077438354
   Union Activity: 7.3596379542566623

Returning to FIG. 1, in various embodiments, the database 130 includes properties of each of the predefined workflow activities available in application 108 and/or workflow assistant tool 104. For example, each predefined workflow activity includes properties, such inbound cardinality corresponding to the number of workflow activities that can transition to the workflow activity, outbound cardinality corresponding to the number of workflow activities that can transition from the workflow activity, and workflow activity type. For example, a “targeting” workflow activity type corresponds to workflow activities that build one or more targets, such by performing a query workflow activity. As another example, a “flow control” workflow activity type corresponds to workflow activities that are used to coordinate workflow activities, such as by performing an alert workflow activity. An example of workflow activity types of various predefined workflow activities available in application 108 and/or workflow assistant tool 104 is shown in workflow activities tab 304 of FIG. 3.

Returning to FIG. 1, in various embodiments, the workflow assistant tool 104 generates predefined workflow activity nodes based on the properties of each of the predefined workflow activities available in application 108 and/or workflow assistant tool 104 and stores the predefined workflow activity nodes in the workflow activity nodes 134 data store. Each predefined workflow activity node includes properties of the predefined workflow activity, such inbound cardinality corresponding to the number of workflow activities that can transition to the workflow activity, outbound cardinality corresponding to the number of workflow activities that can transition from the workflow activity, and/or workflow activity type. In certain embodiments, the workflow activity nodes are defined using incident encoding. For example, incident encoding can optimize description of a graph data structure to an LLM by describing the nodes of the graph and how each node of the graph is connected to the other.

Continuing with the example described in relation to FIGS. 3-6, the following workflow activity nodes “G1” may be determined to be relevant:

```
G1 = {
  “nodes”: {
    “schedule”: {
      “type”: “flow control”,
      “inbound”: (0, 0), # Min and max inbound cardinality
      “outbound”: (1, 1), # Min and max outbound cardinality
      “transitions_to”: [“query”, “ ... and so on”]
    },
    “query”: {
      “type”: “targeting”,
      “inbound”: (1, “n”), # Min inbound is 1, max is n
      “outbound”: (1, 1), # Exactly one outbound
      “transitions_to”: [“fork”, “deliveryEmail”, “ ... and so on”]
    },
    “fork”: {
      “type”: “flow control”,
      “inbound”: (1, 1), # Exactly one inbound
      “outbound”: (1, “n”), # Min outbound is 1, max is n
      “transitions_to”: [“query”, “deliveryEmail”, “ ... and so on”]
    },
    “deliveryEmail”: {
      “type”: “delivery”,
      “inbound”: (1, “n”), # Min inbound is 1, max is n
      “outbound”: (1, 1), # Exactly one outbound
      “transitions_to”: [“wait”]
    },
    “wait”: {
      “type”: “flow control”,
      “inbound”: (1, 1), # Exactly one inbound
      “outbound”: (1, 1), # Exactly one outbound
      “transitions_to”: [“query”, “deliveryEmail”, “ ... and so on”]
    },
    “end”: {
      “type”: “flow control”,
      “inbound”: (1, “n”), # Min inbound is 1, max is n
      “outbound”: (0, 0), # No outbound transitions
      “transitions_to”: [ ]
    }
  }
}
```

Returning to FIG. 1, in various embodiments, once the relevant predefined workflow activities are determined, workflow graph engine 142 of the workflow assistant tool 104 causes the LLM (e.g., machine learning model(s) 126) to generate a workflow graph data structure with natural language configuration descriptions for each workflow activity node of the workflow graph data structure based on a prompt with (1) the user input 128, (2) the predefined workflow activity nodes corresponding to each of the relevant workflow activities and (3) instructions to generate the workflow graph data structure based on the user input 128 and the predefined workflow activity nodes. In various embodiments, the instructions to generate the workflow graph data structure include instructions that each workflow activity node must represent an instance of a workflow activity and the edges must represent transitions between these workflow activity instances. In various embodiments, the instructions to generate the workflow graph data structure include instructions that cardinality rules specific to each workflow activity node must be handled when the graph is being generated. For example, for workflow activities with strict cardinality constraints (e.g., the workflow activity “wait” supports one-to-one transitions), the LLM must address the cardinality constraints, such as by duplicating the node or introducing intermediary nodes where necessary to maintain compliance with the cardinality constraints. In various embodiments, the instructions to generate the workflow graph data structure include instructions to generate natural language configuration descriptions for each workflow activity node of the workflow graph data structure to indicate how the workflow activity should be configured including natural language description corresponding to inputs, outputs, and/or the conditions under which the workflow activity should operate. In various embodiments, the instructions to generate the workflow graph data structure include instructions to assign unique identifiers to each instance of a workflow activity to avoid ambiguity in workflows with repeated workflow activities.

Continuing with the example described in relation to FIGS. 3-6, the following workflow graph data structure “G2” may be output by an LLM:

```
G2 = {
  “nodes”: {
    “schedule_1”: {“type”: “schedule”},
    “query_1”: {“type”: “query”},
    “fork_1”: {“type”: “fork”},
    “query_2”: {“type”: “query”},
    “query_3”: {“type”: “query”},
    “deliveryEmail_1”: {“type”: “deliveryEmail”},
    “deliveryEmail_2”: {“type”: “deliveryEmail”},
    “wait_1”: {“type”: “wait”},
    “wait_2”: {“type”: “wait”},
    “query_4”: {“type”: “query”},
    “query_5”: {“type”: “query”},
    “deliveryEmail_3”: {“type”: “deliveryEmail”},
    “deliveryEmail_4”: {“type”: “deliveryEmail”},
    “end_1”: {“type”: “end”},
    “end_2”: {“type”: “end”}
  },
  “edges”: {
    “schedule_1”: [“query_1”],
    “query_1”: [“fork_1”],
    “fork_1”: [“query_2”, “query_3”],
    “query_2”: [“deliveryEmail_1”],
    “query_3”: [“deliveryEmail_2”],
    “deliveryEmail_1”: [“wait_1”],
    “deliveryEmail_2”: [“wait_2”],
    “wait_1”: [“query_4”],
    “wait_2”: [“query_5”],
    “query_4”: [“deliveryEmail_3”],
    “query_5”: [“deliveryEmail_4”],
    “deliveryEmail_3”: [“end_1”],
    “deliveryEmail_4”: [“end_2”]
  }
}
```

Continuing with the example described in relation to FIGS. 3-6, the following natural language configuration descriptions for each workflow activity node of workflow graph data structure “G2” may be output by an LLM:

```
‘activities': {
  ‘schedule_1’: ‘Configure this activity to trigger at 10:00 AM daily.’,
  ‘query_1’: ‘Configure this query to select customers who have
  registered in the last 24 hours.’
  ‘fork_1’: ‘Use this fork to create two paths for sending emails based
  on gender.’,
  ‘query_2’: ‘Configure this query to filter male customers from the
  results of query_1.’,
  ‘query_3’: ‘Configure this query to filter female customers from the
  results of query_1.’,
  ‘deliveryEmail_1’: ‘Configure this delivery to send a welcome
  email to male customers.’,
  ‘deliveryEmail_2’: ‘Configure this delivery to send a welcome
  email to female customers.’,
  ‘wait_1’: ‘Set this wait for 5 days to delay the reminder email for
  male customers.’,
  ‘wait_2’: ‘Set this wait for 5 days to delay the reminder email for
  female customers.’,
  ‘query_4’: ‘Configure this query to select male customers who have
  not opened the welcome email.’,
  ‘query_5’: ‘Configure this query to select female customers who
  have not opened the welcome email.’,
  ‘deliveryEmail_3’: ‘Configure this delivery to send a reminder
  email to male customers.’,
  ‘deliveryEmail_4’: ‘Configure this delivery to send a reminder
  email to female customers.’,
  ‘end_1’: ‘Mark the end of the workflow for male customers.’,
  ‘end_2’: ‘Mark the end of the workflow for female customers.’,
}
```

Returning to FIG. 1, in various embodiments, once the LLM has generated the workflow graph data structure representing the user input 128, the validation and correction engine 144 of the workflow assistant tool 104 performs validation and error detection. For example, the validation and correction engine 144 performs node validation by ensuring all nodes of the workflow graph data structure (e.g., G2) exist in the predefined workflow activity nodes (e.g., G1). As another example, the validation and correction engine 144 performs edge validation by checking if the edges of the workflow graph data structure (e.g., G2) connect valid nodes from the workflow activity nodes (e.g., G1). As another example, the validation and correction engine 144 performs cardinality validation by verifying that the number of inbound and outbound transitions for each node of the workflow graph data structure (e.g., G2) complies with the cardinality rules defined in the predefined workflow activity nodes (e.g., G1).

Continuing with the example described in relation to FIGS. 3-6, the following instructions can be utilized for validation and error detection:

```
def validate_graph(G1, G2):
  errors = [ ]
  # Nodes Validation: Ensure all nodes in G2 exist in G1
  for node, properties in G2[“nodes”].items( ):
    if properties[“type”] not in G1[“nodes”]:
      errors.append(f“Node {node} with type {properties[‘type’]} does
not exist in G1.”)
  # Edge Validation: Check if edges in G2 connect valid nodes from G1
  for src, targets in G2[“edges”].items( ):
    if src not in G2[“nodes”]:
      errors.append(f“Source node {src} is missing in G2.”)
    for target in targets:
      if target not in G2[“nodes”]:
        errors.append(f“Target node {target} from {src} is missing in
G2.”)
```

| | | |
|---|---|---|
| elif | G2[“nodes”][target][“type”] not | in |

```
G1[“nodes”][G2[“nodes”][src][“type”]][“transitions_to”]:
        errors.append(f“Edge {src} -> {target} is invalid based on G1
transitions.”)
  # Cardinality Validation: Verify cardinality rules for each node in G2
  inbound_counts = {node: 0 for node in G2[“nodes”]}
  outbound_counts = {node: 0 for node in G2[“nodes”]}
  for src, targets in G2[“edges”].items( ):
    outbound_counts[src] += len(targets)
    for target in targets:
      inbound_counts[target] += 1
  for node, count in inbound_counts.items( ):
```

| | | |
|---|---|---|
| min_in, | max_in | = |

```
G1[“nodes”][G2[“nodes”][node][“type”]][“inbound”]
  if count < min_in or (max_in != “n” and count > max_in):
    errors.append(f“Node {node} violates inbound cardinality: {count}
(expected {min_in}−{max_in}).”)
  for node, count in outbound_counts.items( ):
```

| | | |
|---|---|---|
| min_out, | max_out | = |

```
G1[“nodes”][G2[“nodes”][node][“type”]][“outbound”]
    if count < min_out or (max_out != “n” and count > max_out):
      errors.append(f“Node {node} violates outbound cardinality:
{count} (expected {min_out}−{max_out}).”)
  # Return validation result
  if errors:
    return {“status”: “failed”, “errors”: errors}
  return {“status”: “success”, “message”: “Graph G2 is valid
  against G1.”}
```

In this regard, validating the workflow graph data structure “G2 generated by the LLM against the predefined workflow activity nodes “G1” provided to the LLM ensures the transitions (e.g., edges) between workflow activity nodes comply with the cardinality rules and other constraints defined the workflow activity nodes “G1.”

Returning to FIG. 1, in various embodiments, when errors are detected, the validation and correction engine 144 of the workflow assistant tool 104 performs self-correction. For example, as a result of detecting an error, the LLM (e.g., machine learning model(s) 126) is prompted with the error details and workflow activity nodes, such as the workflow activity nodes corresponding to the relevant workflow activities or all of the workflow activity nodes. Continuing this example, the LLM then generates a corrected version of the workflow graph data structure based on the error details. In various embodiments, the correction process continues iteratively (e.g., as a loop) until the workflow graph data structure is validated and no errors are detected. In certain embodiments, the validation and correction engine 144 can generate an error object and appends specific error messages if any violations are detected for use by the LLM to correct the error. For example, the errors could be of the following types: (1) a workflow activity node does not exist, (2), a transition between two workflow activity nodes is not possible, (3), cardinality rules of a workflow activity node are violated, and/or the like. In certain embodiments, validation and correction engine 144 of the workflow assistant tool 104 causes the LLM (e.g., machine learning model(s) 126) to generate a corrected workflow graph data structure based on a prompt with (1) the workflow graph data structure, (2) an indication of the error (e.g., error details, such as an error object with appended error messages) of the workflow graph data structure, (3) predefined workflow activity nodes, such as the workflow activity nodes corresponding to the relevant workflow activities or all of the workflow activity nodes, and (4) instructions to generate the corrected workflow graph data structure based on the workflow graph data structure, the indication of the error, and the predefined workflow activity nodes.

In various embodiments, once the LLM has generated and validated the workflow graph data structure representing the user input 128, structured data object engine 146 of the workflow assistant tool 104 converts the workflow graph data structure to the structured data object 118. For example, the conversion of the validated workflow graph data structure involves a structured parsing mechanism that translates the workflow graph data structure into a DSL format, such as a JSON, XML, and/or the like. In various embodiments, the structured data object 118 represents the workflow from the workflow graph data structure. In certain embodiments, each workflow activity of the workflow of structured data object 118 includes the corresponding natural language configuration description of the workflow activity that was generated by the LLM.

Continuing with the example described in relation to FIGS. 3-6, the following JSON is translated from the validated workflow graph data structure generated by the LLM:

```
{
  ″label″: ″wf3452″,
  ″activities″: {
    ″wait″: [
      {
      ″name″: ″wait1″,
      ″description″: ″wait for 5 days″,
      ″label″: ″Wait″,
      ″transitions″: {
          ″transition″: {
            ″x″: ″0”,
            ″y″: ″0”,
            ″name″: ″transition″,
            ″label″: ″Transition″,
            ″target″: ″query2″,
            ″enabled″: ″true″
          }
      }
    },
    {
      ″name″: ″wait2″,
      ″description″: ″wait for 5 days″,
      ″label″: ″Wait″,
      ″transitions″: {
          ″transition″: {
            ″x″: ″0”,
            ″y″: ″0”,
            ″name″: ″transition″,
            ″label″: ″Transition″,
            ″target″: ″query3″,
            ″enabled″: ″true″
          }
      }
    }
],
    ″query″: [
      {
      ″name″: ″query1″,
      ″label″: ″Query″,
      ″description″: ″filter all the male customers from the results of
query_1″,
      ″transitions″: {
          ″result″: {
            ″x″: ″0”,
            ″y″: ″0”,
            ″name″: ″result″,
            ″label″: ″Result″,
            ″target″: ″extract1″,
            ″enabled″: ″true″
          }
      }
    },
    {
      ″name″: ″query2″,
      ″label″: ″Query″,
      ″description″: ″filter all the female customers from the results of
query_1″,
      ″transitions″: {
          ″result″: {
            ″x″: ″0”,
            ″y″: ″0”,
            ″name″: ″result″,
            ″label″: ″Result″,
            ″target″: ″deliveryEmail4″,
            ″enabled″: ″true″
          }
      }
    },
    {
    ″query3″: {
      ″name″: ″query3″,
      ″label″: ″Query″,
      ″description″: ″select male customers who have not opened the
welcome email″,
      ″transitions″: {
          ″result″: {
            ″x″: ″0”,
            ″y″: ″0”,
            ″name″: ″result″,
            ″label″: ″Result″,
            ″target″: ″deliveryEmail3″,
            ″enabled″: ″true″
          }
      }
    }
  ],
    ″start″: {
      ″name″: ″start1″,
      ″label″: ″Start″,
      ″transitions″: {
          ″initial″: {
            ″x″: ″0”,
            ″y″: ″0”,
            ″name″: ″initial″,
            ″target″: ″schedule1″,
            ″enabled″: ″true″
          }
      }
    },
″extract″: {
  ″name″: ″extract1″,
  ″label″: ″Split″,
  ″schema″: ″temp:query1″,
  ″label″: ″Split the incoming audience into male and female″,
    ″transitions″: {
      ″extractOutput″: [
        {
        ″x″: ″0”,
        ″y″: ″0”,
        ″code″: ″Female audience”,
        ″name″: ″extractOutput”,
        ″label″: ″Female audience”,
        ″target″: ″deliveryEmail2”,
        ″enabled″: ″true”,
        },
        {
        ″x″: ″0”,
        ″y″: ″0”,
        ″code″: ″Male audience”,
        ″name″: ″extractOutput”,
        ″label″: ″Male audience”,
        ″target″: ″deliveryEmail3”,
        ″enabled″: ″true”,
        },
      ]
    }
  },
  ″schedule″: {
      ″name″: ″schedule1″,
      ″label″: ″Scheduler″,
      ″description″: ″Configure this activity to trigger at
      10:00 AM daily.″,
      ″transitions″: {
        “transition”: {
        ″x″: ″0”,
        ″y″: ″0”,
        ″name″: ″transition”,
        ″label″: ″Transition”,
        ″target″: ″query1”,
        ″enabled″: ″true”,
        }
      }
    },
    ″deliveryEmail″: [
      {
        ″name″: ″deliveryEmail1″,
        ″description″: ″New Welcome Email for Male Audience″,
        ″messageType″: ″0″
    },
      {
        ″name″: ″deliveryEmail2″,
        ″description″: ″New Welcome Email for Female Audience″,
        ″messageType″: ″0″
        ″transitions″: {
          “done”: {
            ″x″: ″0”,
            ″y″: ″0”,
            ″name″: ″done”,
            ″label″: ″Result”,
            ″target″: ″wait1”,
            ″enabled″: ″true”,
          }
        }
    },
{
        ″name″: ″deliveryEmail3″,
        ″description″: ″Reminder Welcome Email for Male Audience″,
        ″message Type″: ″0″
        ″transitions″: {
          “done”: {
            ″x″: ″0”,
            ″y″: ″0”,
            ″name″: ″done”,
            ″label″: ″Result”,
            ″target″: ″wait2”,
            ″enabled″: ″true”,
          }
        }
    },
{
        ″name″: ″deliveryEmail4″,
        ″description″: ″Reminder Welcome Email for Female
        Audience″,
        ″messageType″: ″0″
      }
    ]
  }
}
```

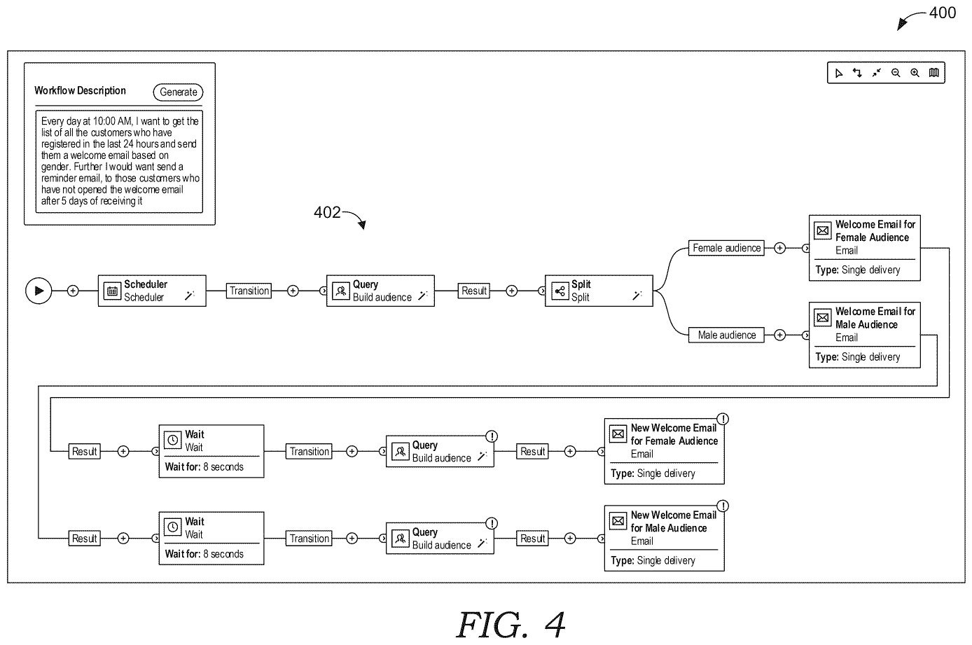

Returning to FIG. 1, in various embodiments, once the structured data object 118 is generated, application 108 can display the workflow to the end user via user device 102 based on the structured data object 118. FIG. 4 is an example user interface 400 of an application that displays the workflow 402 based on the JSON that is translated from the validated workflow graph data structure generated by the LLM as described with respect to FIG. 3.

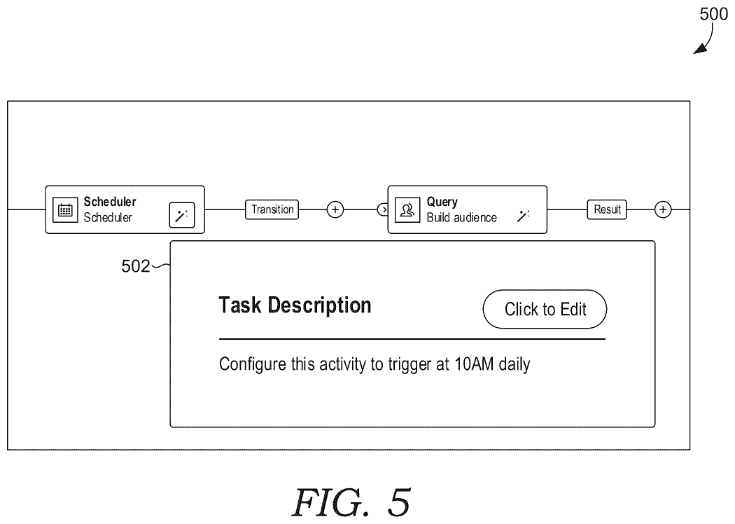

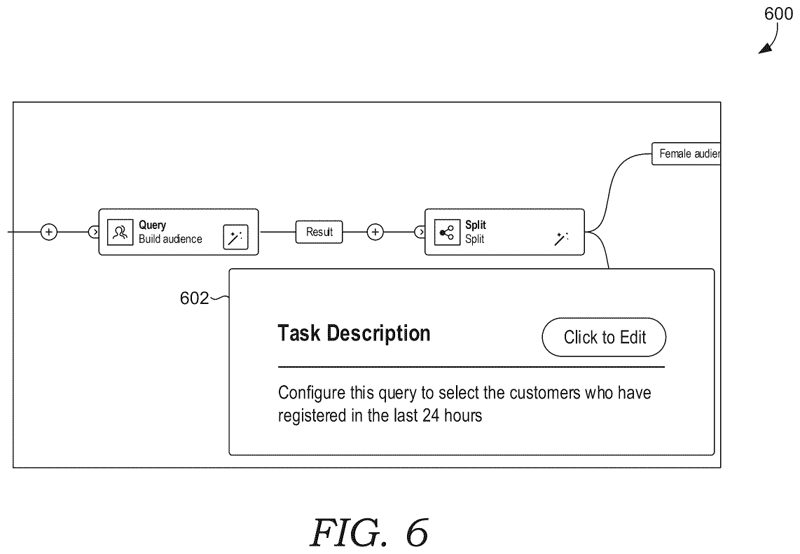

FIG. 5 depicts a user interface 500 of an application that includes a representation of a workflow activity “scheduler” from the workflow 402 of FIG. 4. As can be understood, task description 502 of the workflow activity “scheduler” includes a natural language configuration description indicating “configure this activity to trigger at 10 AM daily.” As another example, FIG. 6 depicts a user interface 600 of an application that includes a representation of a workflow activity “query” from the workflow 402 of FIG. 4. As can be understood, task description 602 of the workflow activity “query” includes a natural language configuration description indicating “configure this query to select customers who have registered in the last 24 hours.”

Returning to FIG. 1, in various embodiments, the structured data object 118 includes natural language configuration descriptions for each workflow activity of the workflow. Using the natural language configuration descriptions for each workflow activity of the workflow, in certain embodiments, workflow activity engine 148 of workflow assistant tool 104 can generate fully configured workflow activities of the structured data object 118 using various embodiments described in U.S. patent application Ser. No. 19/077,481, which is incorporated herein by reference in its entirety. For example, workflow activity engine 148 can include a multistep RAG-based prompt engineering pipeline that interprets the natural language descriptions of the workflow activities and generates fully configured workflow activities.

In various embodiments, workflow activity engine 148 can generate fully configured workflow activities in parallel (e.g., to reduce processing time) based on a corresponding dependency between each of the workflow activities of the workflow. For example, workflow activity engine 148 generates a graph data structure, referred to as “a workflow dependency graph data structure” based on the workflow graph data structure that defines the dependencies of each of the workflow activities of the workflow. In this regard, in certain instances where a second workflow activity depends on a first workflow activity, the fully configured workflow activity of the second workflow activity can only be generated after a fully configured version of the first workflow activity is generated (e.g., and thereby cannot be generated in parallel). In order to generate the workflow dependency graph data structure, workflow activity engine 148 can apply a graph traversal algorithm, such as a breadth-first search (BFS) algorithm, to (e.g., validated) workflow graph data structure to determine the dependencies of each of the workflow activities of the workflow graph data structure. As an example, starting with the first workflow activity node of the validated workflow graph data structure, which is assigned an initial dependency mark (e.g., and initial dependency mark of one), each workflow activity node of the validated workflow graph data structure is traversed and assigned a corresponding dependency mark. When a dependent workflow activity node (such as “Enrich” workflow activity node) is encountered during the graph traversal algorithm, the dependency mark is incremented (e.g., the initial dependency mark is incremented from one to two) and assigned to the subsequent workflow activity nodes. In this regard, the workflow activity nodes sharing the same dependency mark are independent and a fully configured version of the workflow activities corresponding to those workflow activity nodes can be generated in parallel. In various embodiments, the edges between the workflow activity nodes of the workflow dependency graph data structure include data indicating the dependencies between the dependency marks.

As an example, the following instructions can be utilized to generate the workflow dependency graph data structure to determine the fully configured workflow activities that can be generated in parallel:

```
def generate_dependency_graph(G2, dependent_activity_list):
  “““
  Args:
  G2 (dict): The workflow-activity graph.
  dependent_activity_list (list): List of activity names that cause
dependency level increments.
  Returns:
  dict: A dependency graph with nodes grouped by dependency levels.
  ”””
  from collections import defaultdict, deque
  # Initialize data structures
  dependency_graph = defaultdict(set) # {dependency_level: set(nodes)}
  dependency_level_map = {node: 0 for node in G2[“nodes”]} # Node
to level mapping
  inbound_count = {node: 0 for node in G2[“nodes”]} # Count inbound
edges for each node
  # Calculate inbound edge counts
  for from_node, to_nodes in G2[“edges”].items( ):
    for to_node in to_nodes:
      inbound_count[to_node] += 1
  # Identify start nodes (no inbound edges)
  queue = deque([node for node in G2[“nodes”] if
inbound_count[node] == 0])
  while queue:
    current_node = queue.popleft( )
    # Get the current level of the node
    current_level = dependency_level_map[current_node]
    # Assign the node to its dependency level in the graph
    dependency_graph[current_level].add(current_node)
    # Update neighbors
    for to_node in G2[“edges”]. get(current_node, [ ]):
      # Update dependency level for the neighbor
```

| | |
|---|---|
| new_level = current_level + 1 if current_node | in |

dependent_activity_list else current_level

| | |
|---|---|
| dependency_level_map[to_node] | = |

```
max(dependency_level_map[to_node], new_level)
      # Decrease inbound count and add to queue if no more
      dependencies
      inbound_count[to_node] −= 1
      if inbound_count[to_node] == 0:
        queue.append(to_node)
  return dict(dependency_graph)
```

In various embodiments, once the fully configured workflow activities of the workflow are generated and applied to structured data object 118, structured data object 118, as a result of being executed by the application 108 and/or other component illustrated in FIG. 1 (e.g., computing resource service provider 120 and/or database 130), causes the workflow to be executed.

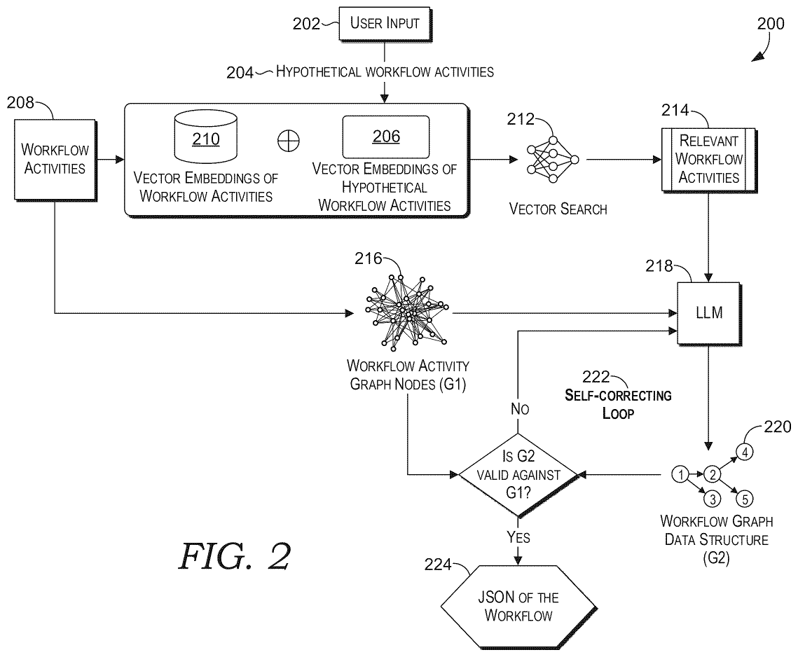

FIG. 2 depicts in environment 200 in which a workflow assistant tool utilizes a user input 202 to generate a workflow encoded in a structured data object corresponding to JSON of the workflow 224, in accordance with at least one embodiment. In various embodiments, the user input 202 is obtained from an application, such as the application 108 described above in connection with FIG. 1. Hypothetical workflow activities 204 are generated based on the user input 202, for example, by applying the user input to an LLM. Vector embeddings of hypothetical workflow activities 206 are generated based on the hypothetical workflow activities 204. Vector embeddings of workflow activities 210 are generated based on actual workflow activities 208 of an application (e.g., application 108 of FIG. 1), for example, based on documentation regarding the workflow activities (e.g., as stored in database 130 of FIG. 1). For each of the vector embeddings of hypothetical workflow activities 206, a vector search (e.g., semantic search) is applied to vector embeddings of workflow activities 210 determine a corresponding relevant workflow activity of relevant workflow activities 214 from workflow activities 208.

Continuing with FIG. 2, workflow activity nodes (G1) 216 are generated based on workflow activities 208. The workflow activity nodes (G1) 216, or a subset thereof based on relevant workflow activities 214, is applied to LLM 218 to generate workflow graph data structure (G2) 220. A self-correcting loop 222 is applied to workflow graph data structure (G2) 220 to determine whether workflow graph data structure (G2) 220 is valid against workflow activity nodes (G1) 216. If the workflow graph data structure (G2) 220 is not valid, the LLM corrects the error and generates a corrected workflow graph data structure (G2) 220. If the workflow graph data structure (G2) 220 is valid, JSON of the workflow 224 is generated. JSON of the workflow 224 can be used by an application (e.g., application 108 of FIG. 1) to cause display of the workflow and/or cause the workflow to be executed.

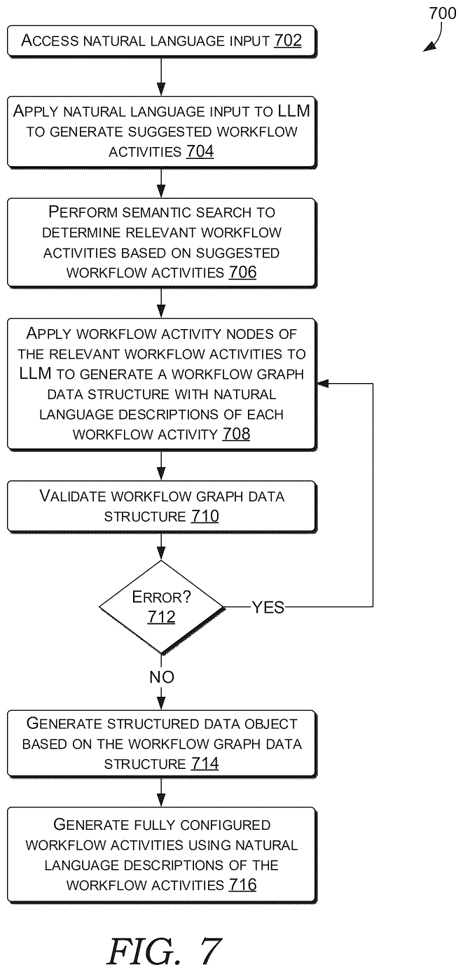

FIG. 7 is a flow diagram showing a method 700 for generating a workflow based on a natural language input in accordance with at least one embodiment. The method 700 can be performed, for instance, by the workflow assistant tool 104 of FIG. 1. Each block of the method 700 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 702, natural language input is accessed. For example, a user provides a natural language query and/or other input to the user interface of an application indicating a workflow the user is attempting to generate. In some examples, a virtual assistant, a query box, and/or other user interface elements are used obtain the user input, which includes a natural language description of a workflow.

At block 704, the natural language input is applied to an LLM to generate suggested workflow activities. For example, the LLM generates a set of suggested workflow activities based on a prompt with the natural language input and instructions to generate a set of suggested workflow activities based on the natural language input. Some examples of LLMs are OPT, FLAN-T5, BART, BERT, GPT-2, GPT-3, and GPT-4.

At block 706, a semantic search is performed to determine relevant predefined workflow activities based on the suggested workflow activities. For example, the most relevant predefined workflow activities (e.g., from the predefined workflow activities of database 130 of FIG. 1) are identified by applying a semantic search between a semantic vector embedding of each suggested workflow activity to the semantic vector embeddings of the predefined workflow activities. For example, in order to generate the semantic vector embeddings of the predefined workflow activities, relevant documentation for a particular predefined workflow activity can be determined using a ranking algorithm, such as Best Match 25. A semantic vector embedding of a particular length (e.g., 1536) for the particular predefined workflow activity can be generated by applying an embedding model to the relevant documentation. In certain embodiments, the cosine similarity is computed between a semantic vector embedding of a suggested workflow activity to the semantic vector embeddings of the predefined workflow activities to identify the most relevant predefined workflow activity for each suggested workflow activity. The predefined workflow activity with the highest similarity score (e.g., or a similarity score above a threshold) is identified as the most relevant to the suggested workflow activity. In certain embodiments, the semantic vector embeddings of the set of suggested workflow activities are determined by applying each suggested workflow activity to an embedding model.

At block 708, predefined workflow activity nodes of the relevant predefined workflow activities are applied to an LLM to generate a workflow graph data structure with natural language descriptions of each workflow activity. For example, an LLM generates the workflow graph data structure with natural language configuration descriptions for each workflow activity node of the workflow graph data structure based on a prompt with (1) the natural language input, (2) predefined workflow activity nodes corresponding to each of the relevant predefined workflow activities, and (3) instructions to generate the workflow graph data structure based on the natural language input and the predefined workflow activity nodes. For example, each predefined workflow activity node includes properties of the predefined workflow activity, such inbound cardinality corresponding to the number of workflow activities that can transition to the workflow activity, outbound cardinality corresponding to the number of workflow activities that can transition from the workflow activity, and/or workflow activity type. In certain embodiments, the workflow activity nodes are defined using incident encoding. In certain embodiments, the instructions to the LLM to generate the workflow graph data structure include instructions that each workflow activity node of the workflow graph data structure must represent an instance of a workflow activity and the edges must represent transitions between these workflow activity instances.

At block 710, the workflow graph data structure is validated. For example, node validation is performed to ensure all nodes of the workflow graph data structure exist in the predefined workflow activity nodes. As another example, edge validation is performed to check if the edges of the workflow graph data structure connect valid nodes from the predefined workflow activity nodes. As another example, cardinality validation is performed to verify that the number of inbound and outbound transitions for each node of the workflow graph data structure complies with the cardinality rules defined in the predefined workflow activity nodes.

At block 712, if there is an error, the LLM generate a corrected workflow graph data structure based on a prompt with (1) the workflow graph data structure, (2) an indication of the error (e.g., error details, such as an error object with appended error messages) of the workflow graph data structure, (3) predefined workflow activity nodes, such as the workflow activity nodes corresponding to the relevant predefined workflow activities or all of the workflow activity nodes, and (4) instructions to generate the corrected workflow graph data structure based on the workflow graph data structure, the indication of the error, and the predefined workflow activity nodes.

At block 714, a structured data object is generated based on the workflow graph data structure. In this regard, the application (e.g. application 108 of FIG. 1) can display the workflow to the end user. In various embodiments, the conversion of the validated workflow graph data structure involves a structured parsing mechanism that translates the workflow graph data structure into a DSL format, such as a JSON, XML, and/or the like. In certain embodiments, each workflow activity of the workflow of the structured data object includes the corresponding natural language configuration description of the workflow activity that was generated by the LLM.

At block 716, fully configured workflow activities are generated using the natural language descriptions of the workflow activities. In this regard, in certain embodiments, once the fully configured workflow activities of the workflow are generated and applied to structured data object, the structured data object, as a result of being executed by the application (e.g., application 108 of FIG), causes the workflow to be executed. In certain embodiments, fully configured workflow activities are generated using a multistep RAG-based prompt engineering pipeline that interprets the natural language descriptions of the workflow activities and generates fully configured workflow activities. In certain embodiments, the fully configured workflow activities can be generated in parallel (e.g., to reduce processing time) based on a corresponding dependency between each of the workflow activities of the workflow.

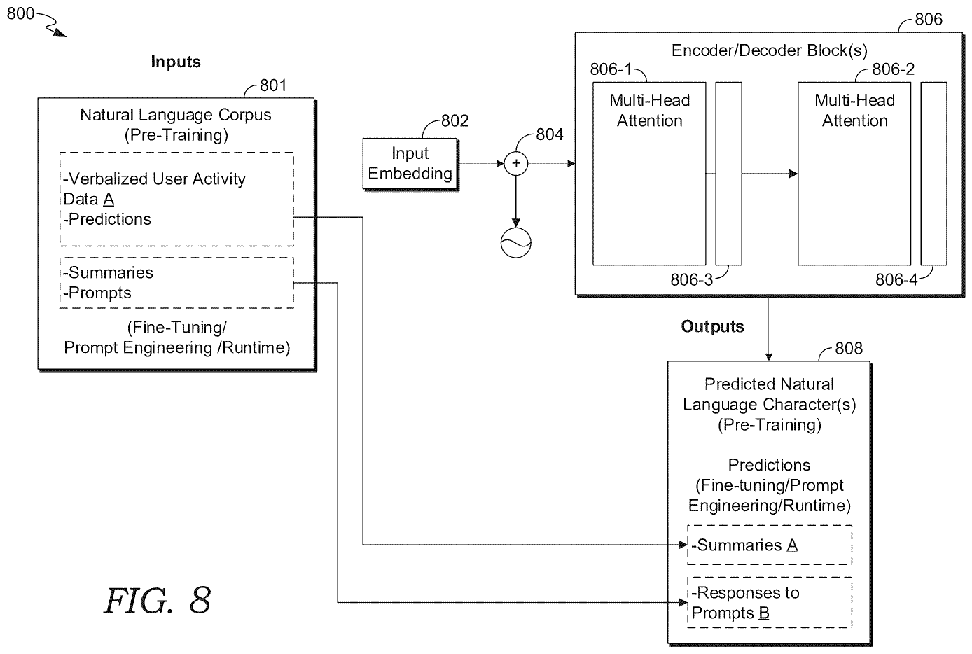

FIG. 8 is a block diagram of a Large Language Model 800 (e.g., a BERT model or GPT-4 model) that uses particular inputs to make particular predictions (e.g., answers to questions), according to some embodiments. In some embodiments, this model 800 represents or includes the functionality as described with respect to the machine learning model(s) 126 of FIG. 1. In various embodiments, the language model 800 includes one or more encoders and/or decoder blocks 806 (or any transformer or portion thereof).

First, a natural language corpus (e.g., various WIKIPEDIA English words or BooksCorpus) of the inputs 801 are converted into tokens and then feature vectors and embedded into an input embedding 802 to derive meaning of individual natural language words (for example, English semantics) during pre-training. In some embodiments, to understand English language, corpus documents, such as textbooks, periodicals, blogs, social media feeds, and the like are ingested by the language model 800.

In some embodiments, each word or character in the input(s) 801 is mapped into the input embedding 802 in parallel or at the same time, unlike existing long short-term memory (LSTM) models, for example. The input embedding 802 maps a word to a feature vector representing the word. However, the same word (for example, “apple”) in different sentences may have different meanings (for example, brand versus fruit). This is why a positional encoder 804 can be implemented. A positional encoder 804 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector as follows:

PE_{(pos,2i)}=sin(pos/10000^{2i/d}^{_{model}})

PE_{(pos,2i+1})=cos(pos/10000^{2i/d}^{_{model}}).

After passing the input(s) 801 through the input embedding 802 and applying the positional encoder 804, the output is a word embedding feature vector, which encodes positional information or context based on the positional encoder 804. These word embedding feature vectors are then passed to the encoder and/or decoder block(s) 806, where they go through a multi-head attention layer 806-1 and a feedforward layer 806-2. The multi-head attention layer 806-1 is generally responsible for focusing or processing certain parts of the feature vectors representing specific portions of the input(s) 801 by generating attention vectors. For example, in Question Answering systems, the multi-head attention layer 806-1 determines how relevant the i^{th} word (or particular word in a sentence) is for answering the question or its relevance to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following formula:

$$Z = softmax ( \frac{Q \cdot {K}^{T}}{\sqrt{Dimension of vector Q , K , or V}} ) \cdot V .$$

For multi-headed attention, there are multiple weight matrices W^{q}, W^{k}, and W^{v} so there are multiple attention vectors Z for every word. However, a neural network may only expect one attention vector per word. Accordingly, another weighted matrix, W^{z}, is used to make sure the output is still an attention vector per word. In some embodiments, after the layers 806-1 and 806-2, there is some form of normalization (for example, batch normalization and/or layer normalization) performed to smoothen out the loss surface, making it easier to optimize while using larger learning rates.

Layers 806-3 and 806-4 represent residual connection and/or normalization layers where normalization recenters and rescales or normalizes the data across the feature dimensions. The feedforward layer 806-2 is a feedforward neural network that is applied to every one of the attention vectors outputted by the multi-head attention layer 806-1. The feedforward layer 806-2 transforms the attention vectors into a form that can be processed by the next encoder block or can make a prediction at 808. For example, given that a document includes the first natural language sequence “the due date is . . . ” the encoder/decoder block(s) 806 predicts that the next natural language sequence will be a specific date or particular words based on past documents that include language identical or similar to the first natural language sequence.

In some embodiments, the encoder/decoder block(s) 806 includes pre-training to learn language (pre-training) and make corresponding predictions. In some embodiments, there is no fine-tuning because some embodiments perform prompt engineering, prompt-tuning, or zero-shot learning. “Prompt engineering” refers to a process of designing or using structured input to the model (referred to as a prompt or prompts) to cause a desired response to be generated by the model. In some embodiments, prompt engineering includes creating the best or optimal prompt, or series of prompts, for the desired user task or output. Accordingly, given a first prompt (which may include target content), if the model produces a first output with a high likelihood of not being the correct response, particular embodiments learn such that a second output (indicative of high likelihood of being the correct response) is always produced when such a first prompt is provided as input. In this way, at model deployment time, no output is ever produced with a low likelihood of being the correct response if the first prompt (or variation thereof) is provided, thereby increasing the accuracy of the model's generative outputs.

Pre-training is performed to understand language, and fine-tuning is performed to learn a specific task, such as learning an answer to a set of questions (in Question Answering systems). In some embodiments, the encoder/decoder block(s) 806 learns what language and context for a word are in pre-training by training on two unsupervised tasks (MLM and NSP) simultaneously or at the same time. In terms of the inputs and outputs, at pre-training, the natural language corpus of the inputs 801 may be various historical documents, such as text books, journals, or periodicals, in order to output the predicted natural language characters in 808 (not make the predictions at runtime or prompt engineering at this point). The encoder/decoder block(s) 806 takes in a sentence, paragraph, or sequence (for example, included in the input[s] 801), with random words being replaced with masks. The goal is to output the value or meaning of the masked tokens. For example, if a line reads, “please [MASK] this document promptly,” the prediction for the “mask” value is “send.” This helps the encoder/decoder block(s) 806 understand the bidirectional context in a sentence, paragraph, or line at a document. In the case of NSP, the encoder/decoder block(s) 806 takes, as input, two or more elements, such as sentences, lines, or paragraphs, and determines, for example, if a second sentence in a document actually follows (for example, is directly below) a first sentence in the document. This helps the encoder/decoder block(s) 806 understand the context across all the elements of a document, not just within a single element. Using both of these together, the encoder/decoder block(s) 806 derives a good understanding of natural language.

In some embodiments, during pre-training, the input to the encoder/decoder block(s) 806 is a set (for example, 2) of masked sentences (sentences for which there are one or more masks), which could alternatively be partial strings or paragraphs. In some embodiments, each word is represented as a token, and some of the tokens are masked. Each token is then converted into a word embedding (for example, 802). At the output side is the binary output for the next sentence prediction. For example, this component may output 1, for example, if masked sentence 2 follows (for example, is directly beneath) masked sentence 1. The output is word feature vectors that correspond to the outputs for the machine learning model functionality. Thus, the number of word feature vectors that are input is the same number of word feature vectors that are output.

In some embodiments, the initial embedding (for example, the input embedding 602) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input[s] 601) that are encoded into a vector (for example, first sentence, second sentence, etc., assuming a top-down and right-to-left approach). The position embeddings are vectors that represent the position of a particular word in such a sentence that can be produced by positional encoder 804. When these three embeddings are added or concatenated together, an embedding vector is generated that is used as input into the encoder/decoder block(s) 806. The segment and position embeddings are used for temporal ordering since all of the vectors are fed into the encoder/decoder block(s) 806 simultaneously and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, once pre-training is performed, the encoder/decoder block(s) 806 performs prompt engineering or fine-tuning on a variety of question and answer datasets by converting different QA formats into a unified sequence-to-sequence format. For example, some embodiments perform the QA task by adding a new question answering head or encoder/decoder block, just the way a masked language model head is added (in pre-training) for performing an MLM task, except that the task is a part of prompt engineering or fine-tuning. This includes the encoder/decoder block(s) 806 processing the inputs 801 (i.e., the verbalized user activity data, the predictions, summaries, and/or prompts) in order to make the predictions and confidence scores as indicated in 808. Prompt engineering, in some embodiments, is the process of crafting and optimizing text prompts for language models to achieve desired outputs. In other words, prompt engineering is the process of mapping prompts (e.g., a question) to the output (e.g., an answer) that it belongs to for training. For example, if a user asks a model to generate a poem about a person fishing on a lake, the expectation is that it will generate a different poem each time. Users may then label the output or answers from best to worst. Such labels are an input to the model to make sure the model is giving more human-like or best answers, while trying to minimize the worst answers (e.g., via reinforcement learning). In some embodiments, a “prompt” as described herein includes one or more of: a request (e.g., a question or instruction [e.g., write a poem]), target content, a command or instruction, and/or more examples (e.g., one-shot or two-shot examples).

In an illustrative example, in some embodiments, the predictions of the output 808 may be generative text, workflows, workflow activities, structured data objects, or other data, such as those described above with reference to FIGS. 3-6. Alternative to prompt engineering or fine-tuning, in some embodiments the inputs 801 and outputs 808 represent “runtime” inputs and outputs. Runtime represents a time after which the model 800 has been trained (e.g., via pre-training and/or fine-tuning and/or prompt engineering), tested, and deployed.

An artificial intelligence (AI) system refers to an artificial intelligence computing environment or architecture that includes the infrastructure and components that support the development, training, and deployment of artificial intelligence models. It provides necessary hardware, software, and frameworks for developers to create and run artificial intelligence applications. An artificial intelligence system may be a cloud-based AI solution that leverages cloud computing infrastructure to develop, train, deploy, and manage AI models and applications. AI models may specifically refer to generative AI models that are designed to generate new data or content that is similar to, or in some cases, entirely different from data they are trained on.

Artificial intelligence systems can include transformer models that are capable of running complex neural language processing tasks. Transformer models—also known as Large Language Models (LLMs)—have applications in a wide range of industries. An LLM is a trained deep learning model that can recognize, summarize, translate, predict, and generate content using very large datasets. LLMs and other types of generative AI models are associated with a training phase—where a model is taught to learn patterns, relationships, and knowledge from training datasets—and an inference phase, which includes making predictions, classifications, or generating outputs for real-world tasks or queries.

Unlike convolution neural networks (CNNs), which are typically used for image tasks and mostly rely on convolution operations, transformer models are based on simple general matrix multiplication (GEMM) tasks, which can be further broken down to perform a dot product operation on two vectors. While CNN architectures are typically computationally heavy with a relatively small number of parameters, the architecture of transformer models results in the opposite: a very large number of parameters with a fairly small number of operations. The LLM architecture can create challenges in that performance bottlenecks reside in the memory throughput and capacity rather than the compute engine.

Transformer models operate with memory accesses to retrieve a matrix of weights out of memory, together with a vector (either the input vector or partial result from a previous stage of the model), and multiplying the two. This is true for the model's attention sublayers, the FFN (feedforward network), sublayers, and for the final embedding layer. As vector-matrix multiplication is actually comprised of numerous vector-vector multiplications (dot product), it is fair to say that most memory accesses are used to read two vectors in order to perform a dot product on them. As such, reading out the full vectors is inefficient.

As such, transformer models (also referred to herein as “generative AI models”) require computational resources including processors and memory for the training phase and inference phase. The generative AI models operate with different types of processors (e.g., central processing units [CPUs] or graphics processing units [GPUs]) in architectures that include multi-core CPUs or parallel processors including GPUs and tensor processing units (TPUs). Memory can be used to store model parameters and intermediate data for the training phase and the inference phase. Memory requirements may depend on the size and the architecture of the generative AI models. By way of illustration, an LLM can support an inferencing phase that includes using a trained model to make predictions, draw conclusions, or generate output based on input data or patterns learned during the model's training phase. During the inference phase, an LLM can use DRAM (Dynamic Random-Access Memory) to store various components and data for making inferences. LLMs can store their pre-trained model parameters (e.g., weights and biases of the neural network layers) in DRAM, and when a new input is provided for inference, the model accesses these parameters from DRAM to make predictions.

The inference phase can be divided into two stages: a prompt stage and an auto-regressive stage. The prompt stage can include receiving and processing input as a batch of new tokens as part of the same inference. The prompt stage may operate based on a Key-Value (KV) cache technique, where a KV cache is created for tokens in a batch. During the prompt stage, the input is being digested. The auto-regressive state can include using the model to generate the tokens one by one, based on previous tokens, relying on reading the KV cache of previously processed tokens, and adding the data of only new tokens to the KV cache. This auto-regressive stage includes the model generating a response to the input from the prompt stage.

Referring now to FIG. 9, FIG. 9 provides an example of a computing device in which embodiments of the present disclosure may be employed. Computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what may be one or more buses (such as an address bus, data bus, or combination thereof). Although the various blocks of FIG. 9 are shown with lines for the sake of clarity, in reality, delineating various components is not so clear, and metaphorically, the lines would more accurately be gray and fuzzy. For example, one may consider a presentation component such as a display device to be an input/output (I/O) component. Also, processors have memory. The inventors recognize that such is the nature of the art and reiterate that the diagram of FIG. 9 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 9 and make reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 900. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, infrared, and other wireless media. Combinations of any of the above should also be included within the scope of computer-readable media.

Memory 912 includes computer storage media in the form of volatile and/or nonvolatile memory. As depicted, memory 912 includes instructions 924. Instructions 924, when executed by processor(s) 914, are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which may be built-in. Illustrative components include a microphone, joystick, game pad, satellite dish, scanner, printer, wireless device, etc. I/O components 920 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 900. Computing device 900 may be equipped with depth cameras, such as stereoscopic camera systems, infrared camera systems, camera systems, and combinations of these, for gesture detection and recognition. Additionally, computing device 900 may be equipped with accelerometers or gyroscopes that enable detection of motion. The output of the accelerometers or gyroscopes may be provided to the display of computing device 900 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order to not obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further subparts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B, and C” means “(A), (B), (C), (A and B), (A and C), (B and C), or (A, B and C).”

What is claimed is:

1. A computing system comprising:
a processor; and
a non-transitory computer-readable medium having stored thereon instructions that when executed by the processor, cause the processor to perform operations including:
generating, by a relevant workflow activity engine, suggested workflow activities corresponding to a workflow based on applying a first prompt to a language model comprising natural language (NL) input corresponding to a NL description of the workflow and instructions to generate the suggested workflow activities;
determining, by the relevant workflow activity engine, relevant workflow activities from predefined workflow activities by performing a semantic search between corresponding semantic vector embeddings of the suggested workflow activities to semantic vector embeddings of the predefined workflow activities;
generating, by a workflow graph engine, a graph data structure corresponding to the workflow comprising NL configuration descriptions of nodes of the graph data structure based on applying a second prompt to the language model comprising the NL input, predefined nodes corresponding to each of the relevant workflow activities, and instructions to generate the graph data structure;
generating, by a structured data object engine, a structured data object corresponding to the workflow based on the graph data structure, the structured data object comprising the NL descriptions of each workflow activity of the workflow; and
causing display of the workflow based on the structured data object.

2. The system of claim 1, wherein the instructions that when executed by the processor, cause the processor to perform operations further including:
validating the graph data structure before generating the structured data object based on validating that each of the nodes of the graph data structure are defined in the predefined nodes, validating that each edge of the graph data structure connect valid nodes of the graph data structure, and validating cardinality of each of the nodes of the graph data structure based on properties of the predefined nodes.

3. The system of claim 1, wherein the instructions that when executed by the processor, cause the processor to perform operations further including:
responsive to detecting an error in the graph data structure, correcting the graph data structure based on applying a third prompt to the language model comprising the graph data structure, an indication of the error, the predefined workflow activity nodes, and instructions to correct the graph data structure.

4. The system of claim 1, wherein the instructions that when executed by the processor, cause the processor to perform operations further including:
generating fully configured workflow activities of the structured data object based on the NL configuration descriptions of workflow activities using a Retrieval-Augmented Generation (RAG)-based prompt engineering pipeline; and
causing the workflow to be executed based on the structured data object.

5. The system of claim 1, wherein the instructions that when executed by the processor, cause the processor to perform operations further including:
generating fully configured workflow activities of the structured data object in parallel based on a corresponding dependency between the nodes of the graph data structure; and
causing the workflow to be executed based on the structured data object.

6. The system of claim 1, wherein the instructions that when executed by the processor, cause the processor to perform operations further including:
generating semantic vector embeddings of the predefined workflow activities based on:
determining relevant documentation for a particular predefined workflow activity using a ranking algorithm; and
generating a particular semantic vector embedding of the particular predefined workflow activity by applying the relevant documentation to an embedding model.

7. The system of claim 1, wherein performing the semantic search further comprises:
for each of the suggested workflow activities, determining a corresponding predefined workflow activity with a greatest similarity by computing a cosine similarity between a particular corresponding semantic vector embedding of a particular suggested workflow activity and the semantic vector embeddings of the predefined workflow activities.

8. The system of claim 1, wherein the predefined nodes comprise properties of the predefined workflow activities, the properties providing data indicating inbound cardinality, outbound cardinality, and workflow activity type.

9. The system of claim 1, wherein the predefined nodes are defined using incident encoding.

10. The system of claim 1, wherein generating the structured data object further comprises:
parsing the graph data structure based on a domain-specific language associated with an application that causes display of the workflow.

11. A non-transitory computer-readable medium storing executable instructions, which when executed by a processing device, cause the processing device to perform operations comprising:
causing a language model to generate suggested workflow activities corresponding to a workflow based on a first prompt comprising natural language (NL) input corresponding to a NL description of the workflow and instructions to generate the suggested workflow activities;
determining, by a relevant workflow activity engine, relevant workflow activities from predefined workflow activities by performing a semantic search between corresponding semantic vector embeddings of the suggested workflow activities to semantic vector embeddings of the predefined workflow activities;
causing the language model to generate a graph data structure corresponding to the workflow based on a second prompt to the language model comprising the NL input, predefined nodes corresponding to each of the relevant workflow activities, and instructions to generate the graph data structure;
generating, by a structured data object engine, a structured data object corresponding to the workflow based on the graph data structure, the structured data object comprising NL descriptions of each workflow activity of the workflow;
generating, by a workflow activity engine, fully configured workflow activities of a structured data object based on the NL configuration descriptions of workflow activities; and
causing the workflow to be executed based on the structured data object.

12. The media of claim 11, the method further comprising:
validating the graph data structure before generating the structured data object based on validating that each of the nodes of the graph data structure are defined in the predefined nodes, validating that each edge of the graph data structure connect valid nodes of the graph data structure, and validating cardinality of each node of the graph data structure based on properties of the predefined nodes.

13. The media of claim 11, the method further comprising:
responsive to detecting an error in the graph data structure, correcting the graph data structure based on applying a third prompt to the language model comprising the graph data structure, an indication of the error, the predefined workflow activity nodes, and instructions to correct the graph data structure.

14. The media of claim 11, the method further comprising:
generating fully configured workflow activities of the structured data object using a Retrieval-Augmented Generation (RAG)-based prompt engineering pipeline in parallel based on a corresponding dependency between the nodes of the graph data structure.

15. The media of claim 11, the method further comprising:
generating semantic vector embeddings of the predefined workflow activities based on:
determining relevant documentation for a particular predefined workflow activity using a ranking algorithm; and
generating a particular semantic vector embedding of the particular predefined workflow activity by applying the relevant documentation to an embedding model.

16. The media of claim 11, wherein performing the semantic search further comprises:
for each of the suggested workflow activities, determining a corresponding predefined workflow activity with a greatest similarity by computing a cosine similarity between a particular corresponding semantic vector embedding of a particular suggested workflow activity and the semantic vector embeddings of the predefined workflow activities.

17. The media of claim 11, wherein the predefined nodes comprise properties of the predefined workflow activities, the properties providing data indicating inbound cardinality, outbound cardinality, and workflow activity type.

18. The media of claim 11, wherein the predefined nodes are defined using incident encoding.

19. The media of claim 11, wherein generating the structured data object further comprises:
parsing the graph data structure based on a domain-specific language associated with an application that causes display of the workflow.

20. A computer-implemented method comprising:
accessing natural language (NL) input corresponding to a NL description of a workflow;
causing a language model to generate suggested workflow activities corresponding to a workflow based on a first prompt comprising the NL input and instructions to generate the suggested workflow activities determining, by a relevant workflow activity engine, relevant workflow activities from predefined workflow activities by performing a semantic search between corresponding semantic vector embeddings of the suggested workflow activities to semantic vector embeddings of the predefined workflow activities;
causing the language model to generate a workflow graph data structure corresponding to the workflow comprising NL configuration descriptions of workflow activity nodes of the graph data structure based on a second prompt to the language model comprising the NL input, predefined workflow activity nodes corresponding to each of the relevant workflow activities, and instructions to generate the workflow graph data structure;
generating, by a structured data object engine, a structured data object corresponding to the workflow based on the workflow graph data structure, the structured data object comprising the NL descriptions of each workflow activity of the workflow; and
causing display of the workflow based on the structured data object.
